(19) United States
(12) Patent Application Publication
(10) Pub. No.: US 2019/0292811 A1
(43) Pub. Date: Sep. 26, 2019

(54) STRIKE ASSEMBLY FOR LOCKS

(71) Applicant: BONAITI SERRATURE S.P.A., Calolziocorte, Lecco (IT)

(72) Inventor: Luigi BOLOGNESI, Laglio (IT)

(21) Appl. No.: 16/317,298

(22) PCT Filed: Jul. 13, 2017
(86) PCT No.: PCT/EP2017/067757

§ 371 Date: Jan. 11, 2019

(30) Foreign Application Priority Data
Jul. 14, 2016 (IT) 102016000073496

(51) Int. Cl. E05B 15/02; E05B 9/08; E05B 15/16

(52) U.S. Cl. CPC E05B 15/0205; E05B 9/082; E05B 9/002; E05B 2015/1671; E05B 15/1635

(57) ABSTRACT

A strike assembly for a mechanical or magnetic lock including an elongated body configured as a cup having a receiving cavity that is opened frontally to engage the bolt or the latch of the lock, and holes for fixing screws with a support element. The strike assembly further includes a separate face plate, having an opening that conforms to the cavity of the cup body for the bolt or the latch of the lock. In the assembled condition, the face plate is superimposed on the cup body, hiding the holes of the fixing screws; the face plate is further provided with rear legs configured with fitting portions for fitting to the cup body.

### BACKGROUND OF THE INVENTION

The present invention refers to a strike assembly for locks of doors and the like, of both mechanical and magnetic type, and in particular relates to a strike assembly that is suitably configured for improving the aesthetic appearance, hiding from view the screws normally used for fixing to the frame of a door or other support element.

### PRIOR ART

A strike device for locks consists in general of a flat plate, which is variously configured, having one or more openings that are suitable for engaging the bolt or the latch of a lock, and holes per fixing screws to the frame of a door or other support element; the fixing screws are normally visible and can be oriented orthogonally or be tilted laterally, with a result that is hardly pleasing aesthetically and with the risk of a garment getting torn if the screws are incorrectly tightened or of injuring a person with whom they may come into contact accidentally. Counter plates of conventional type are shown for example in U.S. Pat. No. 4,854,622, AT 004700 and US 2016/069105.

Strike devices for locks are also known that substantially consist of a face plate having holes for the fixing screws, configured with a central opening for engaging a latch or a bolt of a lock, from a rear side of which a cup-shaped body extends that is intended to receive the latch or the bolt of the lock as a single piece with the face plate.

The cup-shaped body rear body can further be configured for receiving a magnet, if the strike element is used in combination with magnetic locks of known type.

Examples of similar strike devices are shown in DE2921201, USD461700 and IT1377400.

In all these solutions, the strike device is again fixed to a frame of a door, or another suitable support, by screws that are fully in view; thus, the aesthetic appearance of the counter plate cannot be modified in any manner in order to adapt to different application needs, unless the entire strike device is replaced with another strike device having different exterior features.

In order to remedy in part the problems highlighted above, or in order to anchor the strike device to frames or supports of reduced thickness, it has also been proposed to configure the cup body with holes for the fixing screws outside or inside the cup body; examples of strike elements with inner holes for the screws are found in EP2248968, U.S. Pat. No. 4,186,954, US2008/0265590, U.S. Pat. No. 3,392,998 and AU561724.

Although according to these solutions the fixing screws can be positioned inside the cup body, in practice they are not entirely hidden; further, the inner or tilted arrangement of the screws in the cup body, makes application and subsequent maintenance tasks difficult in certain conditions.

If it is necessary to modify the outer appearance, the entire contrasting device has to be replaced again.

From EP2248967 a counter-plate is known comprising a body for receiving a latch, which is fixed by screws to the frame of a door ow window standing finish, and a mask for covering the aforesaid body and the fixing screws.

This covering mask, although it enables the fixing screws to be hidden, has a geometrical configuration that is rather complex to make and accordingly does not permit remedying of possible processing imprecisions during fitting of the counter plate, for example to a door frame.

### OBJECTS OF THE INVENTION

The need therefore exists of having a different type of strike device for both mechanical and magnetic locks, that from the aesthetic and use point of view enables the fixing screws to be hidden completely, enables easy fitting and intervention by an operator for fixing to a support, and enables the aesthetic appearance of the strike device to be varied in terms of the material used, colour or finish according to different constructional and use needs both before and during installation. Further, it would be desirable to dispose of a strike device that during fitting enables possible misalignments between the latch or bolt and receiving cavity to be remedied rapidly and easily to compensate for undesired processing imprecision. Another object is to provide a strike device provided with a face plate that is simple to produce. In particular, it is desired to provide a face plate that is structurally and geometrically simplified so that it can also be made simply by cutting and folding a plate or a metal sheet.

### SHORT DESCRIPTION OF THE INVENTION

The objects of the invention and a solution to the technical problem indicated above, are also achievable by a strike assembly for both mechanical and magnetic locks, according to claim 1.

In particular, according to the invention a strike assembly for locks has been provided, comprising in combination:
an elongated box body, inside which a receiving cavity is defined, that is opened frontally, that is suitable for being engaged by the latch or the bolt of the lock, said box body being provided with holes for receiving screws for fixing in a housing seat of a support element;
a face plate that consists of a cover piece that is separate and distinct from said box body, having an opening and being conformed to couple with said box body and extending to overlap the holes for the fixing screws,
on said face plate (11) there being obtained a rear annular protrusion bounding said opening and rear legs that extend to a greater depth than said annular protrusion, said rear legs being configured with snap or press fitting means to engage corresponding seats of said box body,
on said box body there being obtained slits for receiving said rear legs and an annular recess extending peripherally around said receiving cavity and arranged for receiving said annular protrusion,
in which the length of said slits is greater than the width of said rear legs and the size in thickness of said annular recess is greater than the thickness of said annular protrusion, to enable said adjustable face plate to be positioned with respect to said box body.

In this manner, according to the present invention, a strike assembly for locks is obtained that is easy to install, aesthetically pleasing, in which the fixing screws are accessible frontally in a manner that is completely similar to a conventional counter-plate, and in which the fixing screws are totally hidden by a frontal flat plate that in the assembled condition can be fixed directly to the box body by snap or press fitting means or by interference, which are in turn hidden inside the housing seat of the cup body.

Accordingly, the face plate, being constructionally separate from the cup body of the strike assembly, can be variously configured in the aesthetic features and outer appearance thereof, to be easily replaced.

Further, the particular structural configuration permits easy positioning between the face plate and the box body that is adjustable to adapt and remedy possible misalignments between the receiving cavity and the latch or bolt, without the need to resort to any type of additional processing or additional assembly operations.

The box body, being cup-shaped, can be made of plastics with relatively reduced costs, whereas the face plate covering the screws can be made of any material, for example of metal, being coloured differently or having a different surface finish. Further, the particular geometric configuration, with uniform thickness, enables the face plate to be obtained easily, also by punching and folding a metal sheet.

### SHORT DESCRIPTION OF THE DRAWINGS

These and other features and advantages of a strike assembly for locks according to the invention will be illustrated in greater detail with reference to the embodiments in the attached drawings, in which:

FIG. 1 is a perspective view of a first embodiment of a strike assembly for locks according to the invention;

FIG. 2 is a side view of the strike assembly of FIG. 1, positioned in a housing seat of a support element;

FIG. 3 is a view according to the line 3-3 of FIG. 2;

FIG. 4 is a perspective view, from the front side and in a disassembled condition, of the cup-shaped box body and of the face plate of the strike assembly of FIG. 1;

FIG. 5 is a perspective view, from the rear side in a disassembled state, of the strike assembly of FIG. 4;

FIG. 6 is a front view of the strike assembly of FIG. 1;

FIG. 7 is a longitudinal section along line 7-7 of FIG. 6;

FIG. 7.1 is a first enlarged detail of FIG. 7;

FIG. 8 is a second enlarged detail of FIG. 7, seen from the rear side;

FIG. 9 is a side view of a second embodiment of a strike assembly for locks according to the invention;

FIG. 10 is a view according to the line 10-10 of FIG. 9;

FIG. 11 is a perspective view from the front side, in assembled condition, of the box body and of the face plate of the strike assembly of FIG. 9;

FIG. 12 is a perspective view from the rear side, in a disassembled condition, of the strike assembly of FIG. 11;

FIG. 13 is a front view of the box body of the strike assembly of FIG. 9;

FIG. 14 is an enlarged detail from the rear side of FIG. 9.

### DETAILED DESCRIPTION OF THE INVENTION

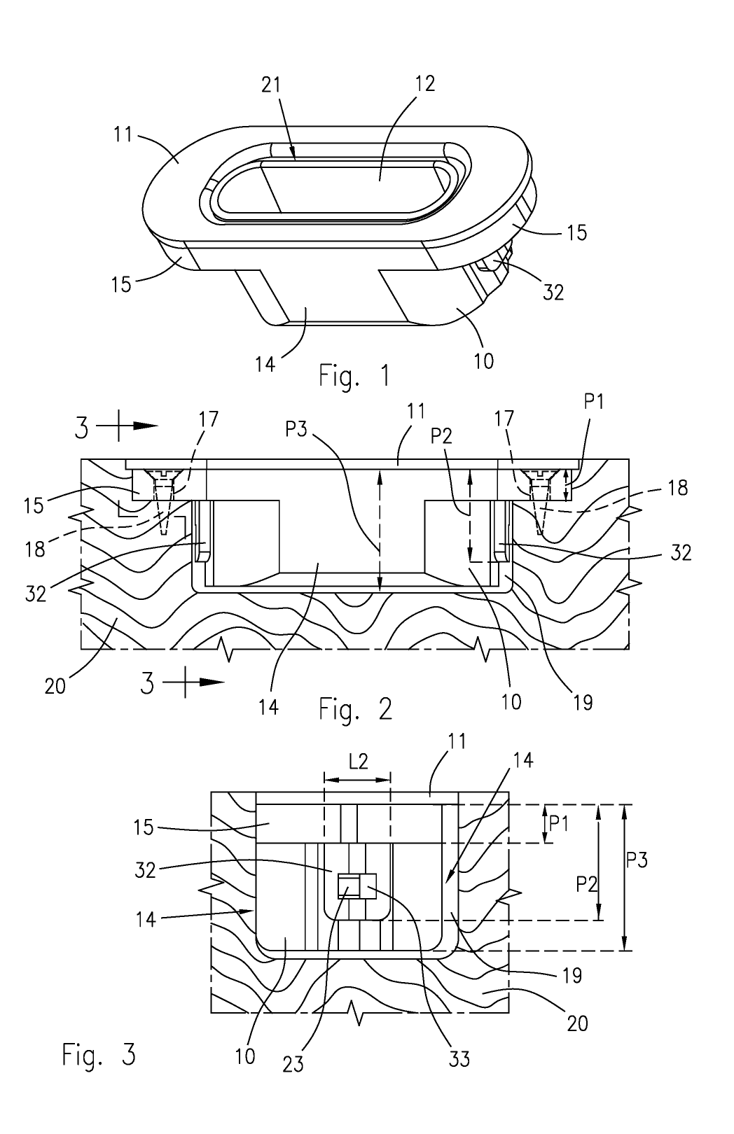

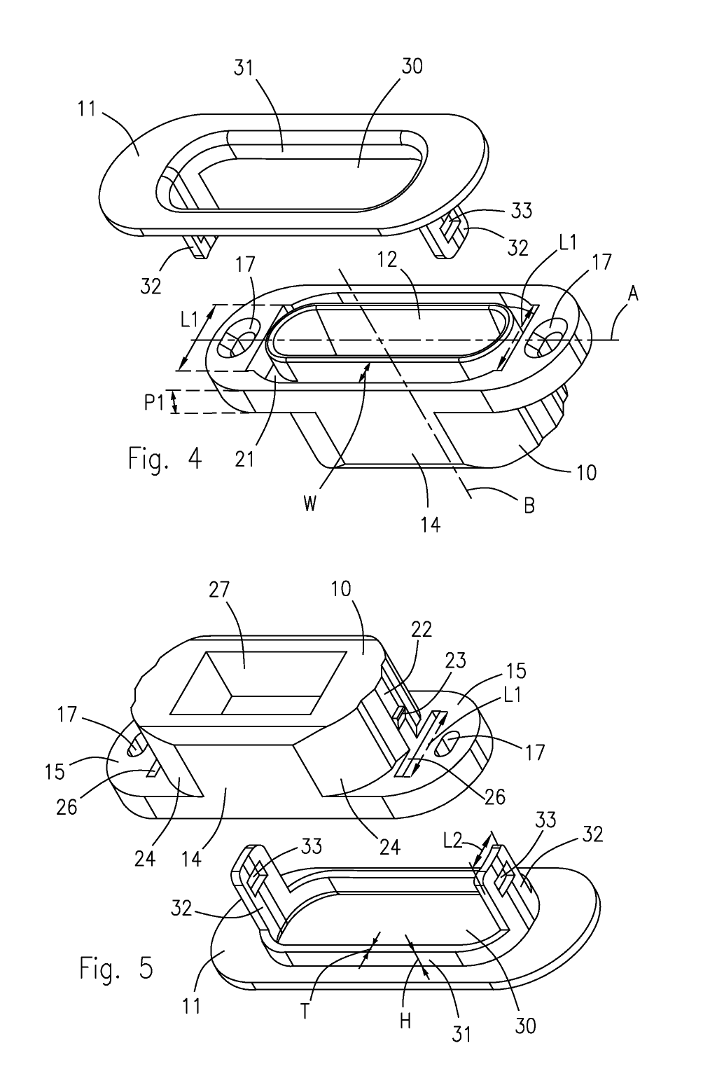

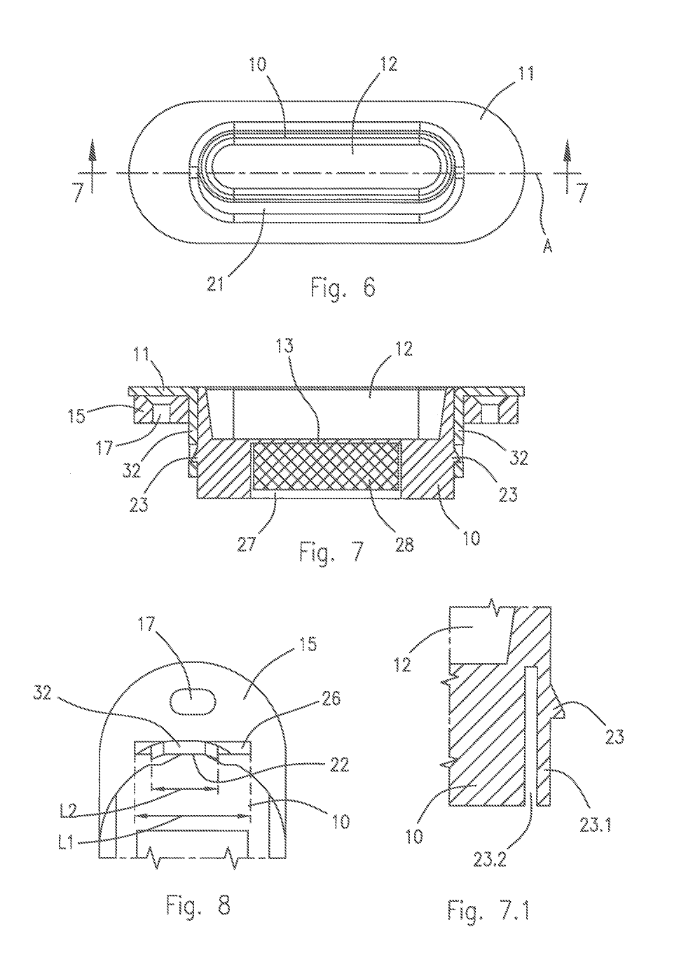

With reference to FIGS. 1 to 8, a first embodiment of a strike assembly for locks according to the invention will be disclosed in greater detail that is suitable for both conventional mechanical locks in which the latch or the bolt of the lock is pushed by a spring through a front opening of a strike element, and for magnetic locks in which a strike element incorporates a permanent magnet that automatically attracts the latch or the bolt of the lock, which is in turn provided with a permanent magnet, in a per se known manner.

As shown in the various figures, the strike assembly for locks comprises un box body 10, in particular shaped as an elongated cup, made for example by plastics moulding, and a covering face plate 11 consisting of a cover piece that is separate and distinct from the aforesaid box body 10. The covering face plate 11 comprises rear legs 32, which are disclosed better below, which are configured with snap or press fitting means for engaging in corresponding seats of the box body 10.

The covering face plate 11 is obtained by punching and folding a metal material, in particular from a plate or a metal sheet, and this entails advantages in terms of simplicity and reduced manufacturing costs. Nevertheless, if desired, the face plate 11 can also be made of another material, for example of plastic, for example by injection moulding.

In particular the cup-shaped box body 10 is configured with receiving cavity 12, that is open at the front, for example a cavity 12 of elongated shape that extends according to a longitudinal axis A of the box body 10, configured with a peripheral wall and a bottom wall 13 (FIG. 7) for receiving the latch or the bolt of a lock.

In the embodiment shown, the box body 10 is configured with flat lateral surfaces 14 that extend from the ends of the cup body 10 parallel to the longitudinal axis A thereof, and with two side wings 15, that have a thickness P1, are coplanar and axially aligned that together with the cup body 10 define a flat frontal surface. The box body 10 extends with a depth dimension P3 that is greater than the thickness P1 of the aforesaid side wings 15.

The side wings 15 connect to the flat lateral surfaces 14 of the cup body 10 and are each provided with a hole 17 for screws 18 accessible frontally for fixing the cup body 10 in a housing seat 19 (FIGS. 2 and 3) formed in the wooden frame or support element 20 by a tool, as shown schematically.

The holes 17 for the fixing screws 18 can be circular, of a diameter corresponding to the diameter of the screws, or, preferably, the holes 17 can be oval or elongated in a direction that is transverse to the longitudinal axis A of the cup body, as shown. In this manner, by making in the support 20 a seat 19 having a width that is slightly greater than that of the cup body 10, it is possible to adjust the lateral position of the body 10 to align the body correctly on the latch or bolt of the lock by applying successively the face plate 11; this can be obtained by positioning the cup body 10 towards or against one or the other of the inner side walls of the housing seat 19, as shown in FIG. 3.

The cup body 10 is further configured with a wide annular recess 21, thickness size W and is arranged peripherally around the receiving cavity 12 of the latch or of the bolt of the lock. The annular recess 21 is arranged for receiving, with a certain slack, an annular protrusion 31 of the face plate 11 disclosed better below.

The cup body 10, at each end, is configured with a first flat surface 22 provided with a detent tooth 23 for holding the front flat plate 11, as explained below. The flat surface 22, as shown in FIG. 5 and in the enlarged detail of FIG. 8, connects on both sides to an arched surface 24, by a second tilted flat surface and a third flat surface that extend along an axis B orthogonal to the longitudinal axis A of the cup body 10, parallel to the sliding direction of the latch or bolt of the lock.

Still in the embodiment of FIGS. 1-8, at the flat surface 22 and the detent tooth 23, each side wing 15 or end of the cup body has a cross slit 26 that opens on both sides and towards the annular recess 21; the slit 26 extends transversely for a portion that is comparatively greater than the width L2 of the corresponding rear legs 32 of the face plate 11, which are configured for permitting snap-fitting with detent teeth 23 of the body 10, as explained below.

More precisely, the length L1 of the slits 26 is greater than the width L2 of the rear legs 32. This feature permits offset positioning of the box body 10—fixed beforehand in the housing seat 19 of the frame of the door or other support element 20—relative to the face plate 11.

If the contrasting assembly is suitable for use with locks of magnetic type, the cup body 10 can be provided with a rear cavity 27, in which a permanent magnet 28 can be housed, as shown in FIG. 7; the magnet 28 can be fixed in the cavity 27, for example by an adhesive, or by configuring the cavity 27 with suitable fitting means for fitting the magnet 28.

Still with reference to the embodiment under consideration, the strike assembly for locks thus comprises a cup body 10 for receiving the latch and the bolt of a lock, configured with side wings 15 provided with holes 17 for the fixing screws, in combination with a front flat plate 11 covering the cup body and the side wings 15 to hide the holes 17 and the fixing screws, in the assembled condition of the strike assembly in which the face plate 11 can be fitted to the cup body 10 after the latter has been correctly positioned in the seat 19 of the frame of a door or another support element.

According to the embodiment of FIGS. 1-8, the face plate 11 can be fixed to the cup body 10 by a snap-fitting system. In particular, the face plate 11 is configured with a large elongated opening 30, bounded by an annular protrusion 31 that projects by a height H to the rear in the depth direction, acting as a rear edge, which is suitable for being inserted, with a certain clearance, into the annular recess 21 of the cup body 10.

In particular, the annular protrusion 31 has a thickness T that is lower—to a more or less relevant degree according to needs—with respect to the thickness size W of the annular recess 21. In other words, the annular protrusion 31 is received with a certain slack in the annular recess 21, so as to enable the face plate 11 to be positioned in an adjustable manner, in particular transversely, with respect to the box body 10. In other words, offset positioning between of the box body 10—fixed beforehand in the housing seat 19 of the frame of the door or other support element 20—relative to the face plate 11 is possible.

The ends of the face plate 11 are further provided with legs 32 that extend to the rear, by an additional length with respect to the annular protrusion 31. The legs 32 project from the rear surface of the face plate 11, with a significant longitudinal dimension P2, which is greater than the height H of the annular protrusion 31, such that, in the assembled condition, they penetrate by a significant amount inside the housing seat 19, such as to achieve excellent anchoring to the box body 10. In the specific embodiment shown, the longitudinal dimension P2 of the legs 32 is greater than the thickness P1 of the side wings 15 of the box body 10, thus the legs 32 penetrate to a much greater depth into the housing seat 19 with respect to the penetration depth of the aforesaid wings 15. The longitudinal dimension P2 of the rear legs is such as to reach, or almost reach, the depth P3 corresponding to the rear end bottom of the box body 10.

The legs 32, in the embodiment of FIGS. 1 to 8, are configured with a wide transverse opening 33 that is suitable for snap engaging a corresponding detent tooth 23 of the cup body 10. Still as shown, the transverse opening 33 of each leg 32 extends transversely for a greater width than the transverse thickness of the detent tooth 23, so as to permit offset positioning between the cup body 10 that has been fixed beforehand in the housing seat 19 of the frame of the door or other support element 20 and the face plate 11.

The legs 32 of the face plate 11 can be configured in any manner, for example they can be configured to have a transversely arched roof-tile configuration, i.e. they have a transverse profile that is curved inwardly, and are such as to enable press-fitting through a respective slit or elongated seat 26 of the cup body 10, for example formed in a corresponding side wing 15 or end of the cup body 10; in this manner when the legs 32 are inserted through the slits 26, they remain firmly fitted to the detent teeth 23, and elastically in contact with the flat surface 22 of the cup body 10, as shown in FIG. 8.

In order to facilitate snap-fitting between each leg 32 of the face plate 11 and the respective detent tooth 23, as shown in the enlarged detail of FIG. 7.1, the detent tooth 23 can be integral with an elastic arm 23.1 at a cross slit 23.2, at each end of the cup body 10; in this manner, the leg 32, during insertion into the slit 26, tends to flex the arm 23.1 backwards slightly, facilitating snap-fitting with the tooth 23.

The significant longitudinal dimension P2 of the rear legs 32 enables to obtain transverse openings 33 that are positioned, in the assembled condition, at a greater depth in the housing seat 19, and accordingly enables the corresponding detent teeth 23 to be arranged at a greater depth than the receiving cavity 12 of the box body 10. Owing to this, the shelf-shaped arm 23.1, and thus the cross slit 23.2 that defines the shelf-shaped arm 23.1, can extend to a greater depth than the receiving cavity 12, without thus weakening the wall that bounds the latter, and thus providing the required flexure elasticity for the aforesaid arm 23.1.

The face plate 11 has overall a uniform thickness that is equal to T. This means that all the zones of the face plate 11, also the rear legs 32, have the same thickness T as the annular protrusion. This feature, advantageously, makes it possible to make the face plate 11 by simple shearing and folding/drawing of a plate or a metal sheet.

Also according to the present invention, as shown in the various figures, the face plate 11 has a width and a length equal to or slightly greater than the width of the cup body 10 measured transversely between the flat lateral surfaces 14, and the length of the box body 10 measured longitudinally between the end edges of the side wings 15. In this manner the face plate 11, when it is assembled on the cup body 10, is superimposed completely on the side wings 15, covering and hiding from view the holes 17 and the fixing screws 18.

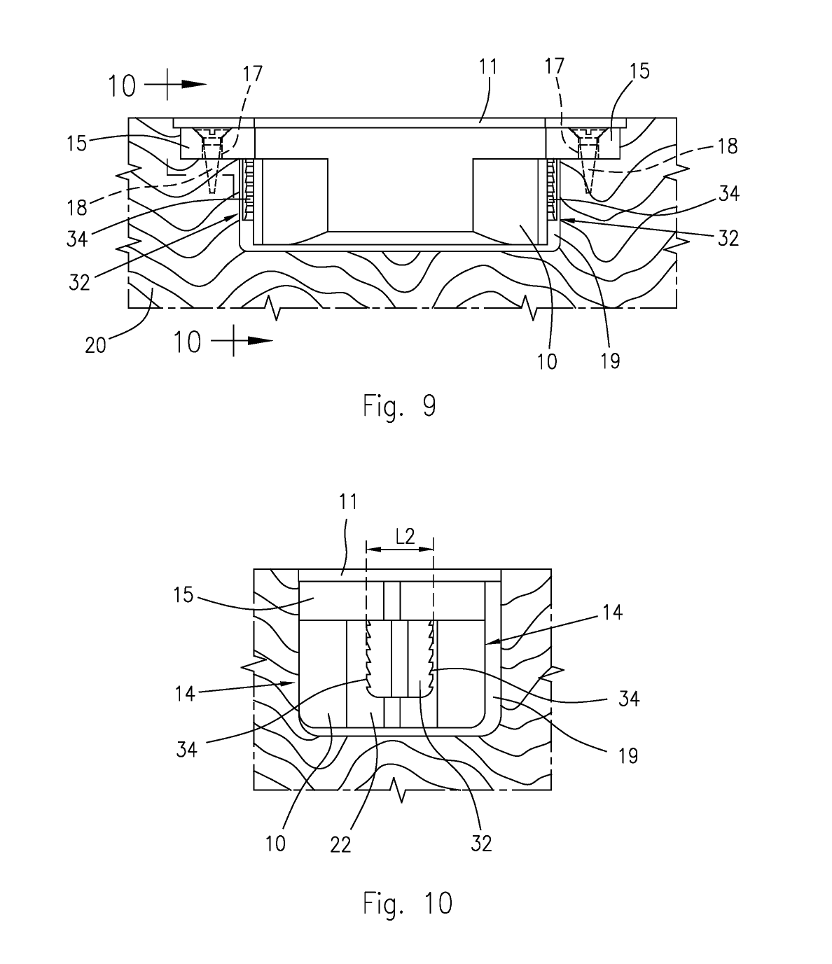

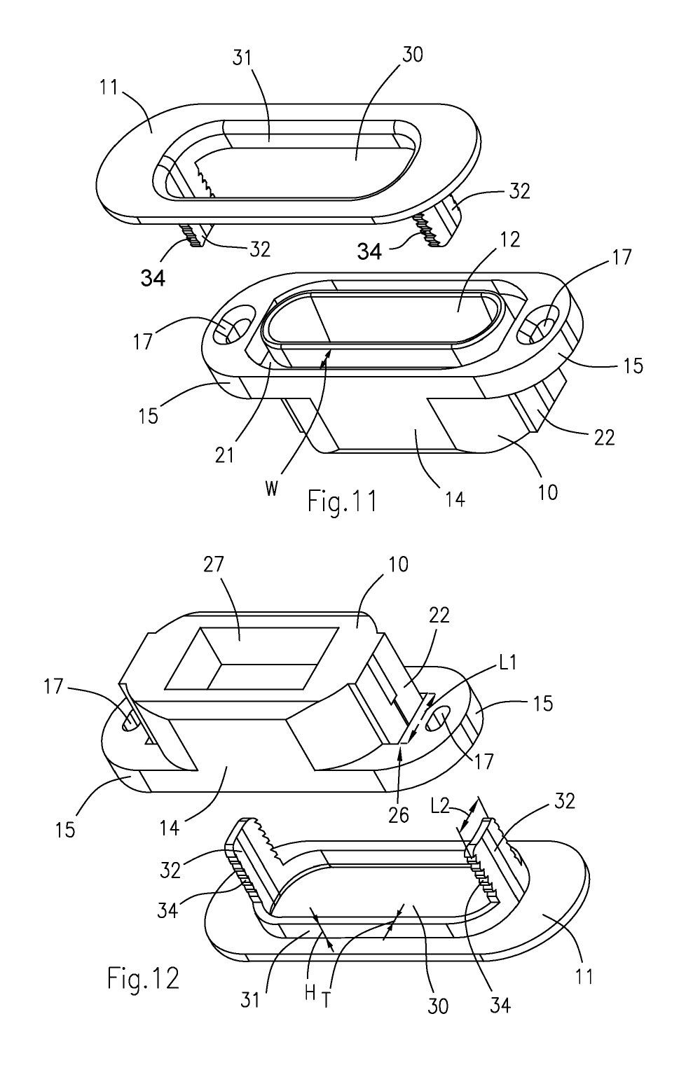

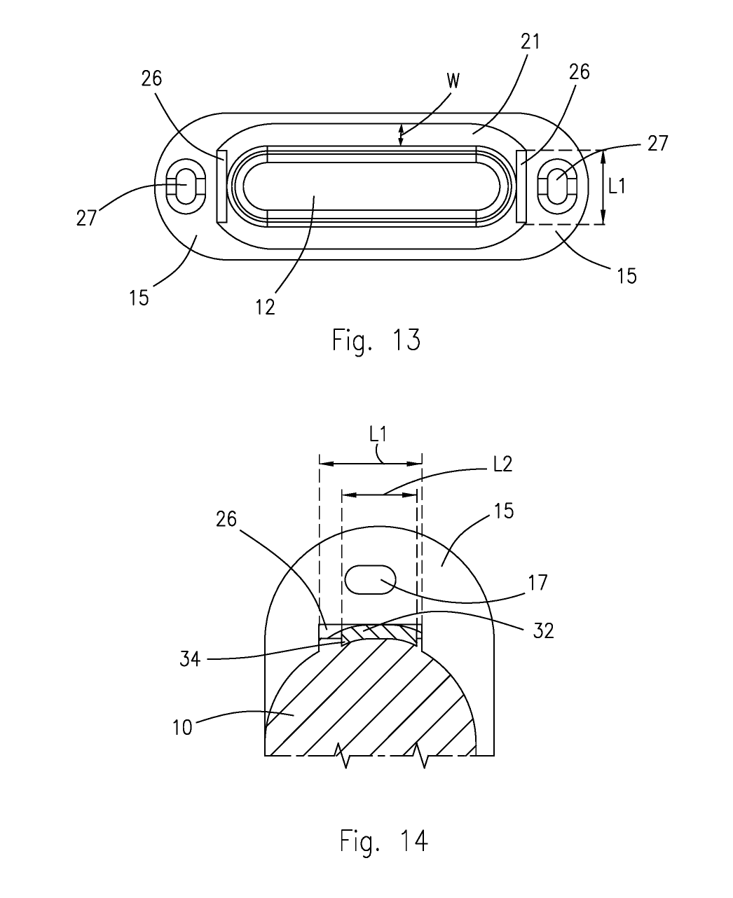

FIGS. 9 to 14 show a second embodiment of the strike assembly for locks according to the invention; the solution of FIGS. 9-14 has all the general features of the preceding embodiment of FIGS. 1-8; thus also in FIGS. 9-14 the same reference numbers of FIGS. 1-8 have been used to indicate the similar or equivalents parts to which reference is made.

Also in this second case the strike assembly for locks comprises a cup body 10 that is similarly configured, provided with coplanar side wings 15 with holes 17 for the fixing screws 18; the cup body 10 is again provided with a cavity 12 that is open frontally to receive the latch or the bolt of a lock, and an annular recess 21, in the form of an annular groove, arranged peripherally to the cavity 12.

Each side wing 15 comprises in turn a cross slit 27 that opens on both sides and towards the annular recess 21, at flat surfaces 22 at the two ends of the cup body 10; lastly, with 27 a rear cavity has been again indicated for housing a possible permanent magnet, in a manner corresponding to the embodiment of FIG. 7.

Still according to this further embodiment, the strike assembly for locks, in addition to the cup body 10, again comprises a face plate 11 similarly configured and having the same function of hiding the holes 17 and the fixing screws 18, according to the embodiment of the preceding figures.

The face plate 11 thus comprises an elongated opening 30 that conforms to the cavity 12 of the cup body 10 for the passage of the latch or bolt of the lock, an annular protrusion 31 protruding on the rear side, and a pair of rear anchoring legs 32.

The embodiment of FIGS. 9-14 differs from the embodiment of FIGS. 1-8 mainly because of the fitting system for fitting the rear legs 32 of the face plate 11 to the box body 10. In fact, in the case of FIGS. 9-14, the rear legs 32 always have a roof-tile shape and are configured with a series of teeth 34 along the two longitudinal edges; the teeth 34, when the legs 32 of the face plate 11 are pushed or inserted through the respective slits 26, penetrate the cup body, anchoring firmly thereto.

The significant longitudinal dimension P2 of the rear legs 32 enables a good distribution of detent teeth 34 to be obtained on the edges of the rear legs 32, which achieve, in the assembled condition, firm gripping of the face plate 11 to the box body 10.

Owing to the roof-tile shape of the legs 32, and the press-fitting thereof into the slits 26, the legs are slightly flattened against the flat surfaces 22 of the cup body 10, as highlighted in the enlarged detail of FIG. 14.

In this manner, the face plate 11, being superimposed on the cup body 10 and on the side wings 15, will again hide the holes 17 and the fixing screws 18.

As the face plate 11 adapts to a seat obtained in the support element 20, maintaining a preset position with respect to the support, and as the cross slits 26 have a length that is greater than the width of the legs 32 of the face plate 11, it will be again possible to pre-adjust beforehand the offset position of the cup body 10 when it is fixed in the housing seat 19, by the fixing screws 18, aligning the front cavity 12 on the latch or bolt of the lock.

In the preceding embodiments, the cup body 10 has been configured with two side wings 15 provided with holes 17 for the fixing screws; nevertheless, the body 10 could be configured differently in the form of a body devoid of side wings, however provided with holes 17 for screws at both ends thereof, and with slits 26 or seats for inserting the rear legs 32 of the face plate 11.

Further, still in the preceding embodiments, the rear legs 32 of the face plate 11 have been configured with a roof-tile shape; nevertheless, the legs 32 of the face plate could be configured differently to be snap-fitted or to be press-fitted into corresponding slits or sides arranged in the body 10. For example, instead of a roof-tile shape, the rear legs 32 of the face plate could be configured in the shape of a stake provided with a tooth or an elastically yieldable head, for snap-fitting or press-fitting into a suitably configured hole in the cup body 10 of the assembly.

In all the cases, the result will be simple and secure fixing of the cup body 10 in the seat 19 of the support element 20, acting frontally on the screws 18, achieving total hiding from view of the holes 17 of the fixing screws 18.

From what has been said and shown, it is thus clear that the strike assembly for mechanical and magnetic locks according to the invention has the following advantages:
the cup body 12 can be easily fixed in a housing seat 19 by screws 18 that are accessible frontally from the outside, in a manner corresponding substantially to a conventional strike element;
the cup body 10 can be positioned beforehand in different offset positions in the housing seat 19, to align the cup body 10 on the latch or bolt of a lock;
the face plate 11 can be subsequently anchored to the cup body 10, after the latter has been fixed to the housing seat 19, completely hiding from view the fixing screws 18;
lastly, it is possible to replace a face plate 11 of a certain type with another fixing plate 11 of a different type, having for example a different surface colour or finish.

Thus other modifications or variations or equivalent solutions can be made to the cup body, to the face plate and to the rear legs, without thereby falling outside the scope of the claims.

1-13. (canceled)

14. A strike assembly for a latch or bolt type lock, comprising in combination:
an elongated box body, inside which a frontal receiving cavity is defined, said cavity being configured for engagement by the latch or the bolt of the lock, said box body including apertures for receiving screws for fixing said box body in a housing seat of a support element;
a face plate including:
i. a cover piece that is separate and distinct from said box body, said face plate having an opening and being conformed to couple with said box body and extending to overlap the apertures for the fixing screws,
ii. a rear annular protrusion bounding said opening and rear legs that extend to a depth greater than said annular protrusion, said rear legs being configured with snap or press fitting portions to engage corresponding seats of said box body,
said box body further comprising slits for receiving said rear legs and an annular recess extending peripherally around said frontal receiving cavity and arranged for receiving said annular protrusion,
wherein the length of said slits is greater than the width of said rear legs and the size in thickness of said annular recess is greater than the thickness of said annular protrusion, to enable said adjustable face plate to be positioned with respect to said box body.

15. The strike assembly for locks according to claim 14, wherein the box body has a cup-shape and is provided at each end with a detent tooth in a position below a respective slit, and in which the rear legs of the face plate are configured with a transverse opening with a respective detent tooth of the cup body.

16. The strike assembly for locks according to claim 15, wherein each detent tooth is integral with an elastically flexible arm of the cup body.

17. The strike assembly for locks according to claim 14, wherein the rear legs of the face plate have a roof-tile configuration and project more deeply than said annular protrusion to extend, in the assembled condition, to a zone adjacent to a bottom of said box body.

18. The strike assembly for locks according to claim 17, wherein said rear legs have a cross sectional profile that is curved inwardly.

19. The strike assembly for locks according to claim 17, wherein the rear legs of said face plate comprise a plurality of detent teeth along lateral edges, configured for penetrating into the cup body in an assembled condition of the strike assembly.

20. The strike assembly for locks according to claim 17, wherein the cup body is bounded by flat lateral surfaces and includes planar shoulder surfaces at both ends for the rear legs of the face plate.

21. The strike assembly for locks according to claim 15, wherein the transverse opening of the rear legs of the face plate has a greater width than the transverse thickness of the detent teeth of the cup body.

22. The strike assembly for locks according to claim 14, wherein said box body has a rear cavity for containing a permanent magnet for use with locks having a magnet latch or bolt.

23. The strike assembly for locks according to claim 14, wherein the apertures for receiving the fixing screws are elongated and extend transversely to the box body of the strike assembly, whereby the elongated apertures enable said box body to be fixed inside said housing seat with an adjustable position.

24. The strike assembly for locks according to claim 14, wherein said box body comprises side wings having a thickness, said side wings including respective cross slits, said box body extending to a depth dimension that is greater than said thickness of said side wings, and wherein said rear legs have a longitudinal dimension that is greater than said thickness of said side wings but less than or the same as said box body depth dimension.

25. The strike assembly for locks according to claim 14, wherein said face plate has a uniform thickness in all the zones.

26. The strike assembly for locks according to claim 14, wherein the box body is made of plastics, and wherein the face plate with the rear legs is made of metal obtained by shearing and folding a metal sheet.
